(19) United States
(12) Patent Application Publication
(10) Pub. No.: US 2014/0046808 A1
(43) Pub. Date: Feb. 13, 2014

(54) Digital package for tourists on organized tours with tourist guide

(71) Applicant: Nissim Ben Yishaayahu, Netanya (IL)

(72) Inventor: Nissim Ben Yishaayahu, Netanya (IL)

(73) Assignee: Nissim Ben Yishaayahu, Netanya (IL)

(21) Appl. No.: 13/572,727

(22) Filed: Aug. 13, 2012

(51) Int. Cl. G06Q 30/06

(52) U.S. Cl. 705/27.1; 705/26.1

(57) ABSTRACT

This invention relates to a system for marketing and purchasing products by a personal device of the tourist guide or the tourist, comprising: a server operable to receive an indication of a purchase by a tourist while on tour or from home, the server transfers the selected product from the company, via Bluetooth, disc on key, USB cable, wire transition or any other digital transferring method know in the art, or online—directly through the internet, to the tourist and the tour guide get his payment. The purchase is interlinked to the tour guide by a code the tourist must enter in each purchase.

### FIELD

This invention relates to marketing a digital package, comprising some digital services, for tourists on organized tours, where the digital products are purchased by the tourist online or offline, from a tourist guide, by entering a tourist guide personal code and buying those digital services. More specific this invention relates to creating a digital journey experience to a tourist by a tour guide.

### BACKGROUND

The tourism field, including international tourism and local tourism, has grown surprisingly fast in the last few years, as a part of the globalization process.

There are 3 different types of touring groups, according to the way the tour is organized: organized tours, touring packages and independent tourists. All 3 types of touring groups use a tour guide, but in organized tours, the tour guide is used more often.

Tourists, including international tourists and local tourists, have some needs during their traveling to several services for the traveling time, therefore, they would be pleased to purchase those services during their journey, and without any commitment. They don't want a long-term contract for a service they don't use. They need to purchase this service without any commitment for a limited time period. These services can be for example: digital books, cellular communication bundle, internet services, digital music, movies, money exchange, digital album, digital video clip and any other digital service.

There is a need for a solution who gives tourists control, and supply an easy solution designed to fit specific needs and budgets during their journey. This solution is useful especially for tourists, who don't want to be obligated to a certain service they don't need, or need a certain service at that time. They pay for the service they need and according to their budget.

Tourists need for example a service for cheep telephone calls, internal or external calls. Most cellular solutions are expansive and tourists usually try to find a cheap solution. This described solution will provides them a new digital journey experience, fitted to their needs.

At the same manner they can take an internet subscription and use it only at the time period they need. There is no need to contact an internet supplier which charges them for a year, for example, when they use it only few days.

Tourists would like to entertain themselves by music, books or movies, in the journey time or at the hotel. They also can purchase from the digital experience system a bundle of music, movies or electronic books from a list they can choose from. This system avoid the need of finding and purchasing the desired books, music and movies they would like to see in their travel, and the need of carry it and find solutions for carry it. This system can help them to be spontaneous and purchase the desired entertainment immediately without any planning.

Tourists, take a lot of pictures during their journey. In the digital period a lot of pictures stay on the computer and people don't see them anymore. Therefore there is a need for digital albums and clip. This system gives the option to send the photos and multimedia products and get back a digital music, pictures, album or clip that will produce in the multimedia lab.

This digital experience system is an excellent solution also for people and families traveling in their own country, for traveling children who wants some entertainment in their trip, or even for people that have a vacation or any other need for a few days digital solution, or want to control they expenses and use those digital solution only when they need it.

The tour guide himself activates the described digital experience system and create a digital journey experience, related to tourists.

Until now there is no solution for tourists who need such solutions, therefore there is a need for a tourist guide which can apply a digital journey experience to his tourists.

### SUMMARY

This invention relates to a system for marketing and purchasing products by a personal device of the tourist guide, comprising: a server operable to receive an indication of a purchase by a tourist while on tour or from home, the server transfers the selected product from the company, via Bluetooth, disc on key, USB cable, wire transition or any other digital transferring method know in the art, or online—directly through the internet, to the tourist and the tour guide get his payment.

In another aspect, this invention relates to a system for marketing and purchasing products by a personal device of the tourist, comprising: connection to a server operable to receive an indication of a purchase by a tourist while on tour or from home, the server transfers the selected product from the company, via Bluetooth, disc on key, USB cable, wire transition or any other digital transferring method know in the art, or online—directly through the internet, to the tourist and the tour guide get his payment

In another aspect this invention relates to a method of marketing and purchasing digital services for organized tours, comprising: a tourist who needs digital services, and has a personal device get in contact with the web site of the company, who sells those services. The tourist may view a digital services catalog including said digital services through the tour guide personal device or through the tourist private personal device. The tourist may press a button and reach (e.g. via a browser) the on-line store of the company, in the main server where he may, after he enters the guide code, make an order and pays by a credit card, in cash or by any other money transfer method known in the art. The tour guide transfer the desired service by Bluetooth, disc on key, USB cable, wire transition or any other transferring method know in the art to the client, who can use it immediately.

The tour guide gets a commission for each sell. The tour guide gets a link to the web site which of the company which includes the digital products, or he can create a private web page which includes those products. When the tourist or the tour guide enters the catalog, this said catalog is placed on one of those places. The personal code of the tourist guide links between the tour guide and the sell, enable it and credit the tour guide with the commission.

In the buying process the tourist must enters the tour guide number, code, name or any digital identification, in order the system to identify the tour guide and gives him his commission. This code enables the tourist guide to links those digital products to his account and get his commission. The tourist must enter this code in order to buy those products for future purchases as well. In future purchases the tourist must enters this code again in order to identify the relevant guide which gets his commission. If the tourist enters the tour guide code, number or name in the future when he gets home, he gets a discount, or he can't purchase additional products.

In another aspect, this invention relates to a method of marketing and purchasing digital services, comprising: a tourist, who needs digital services, chooses a product from a printed catalog option, get in contact through a website or the tour guide personal device who sells those services and has a personal device. The tourist may view a digital services catalog including said digital services through a printed catalog or an online catalog. The tourist may press a button of the preferred option of his personal device or ask the tour guide to do it for him from the tour guide personal device and reach (e.g. via a browser), after he enters the guide code the on-line store in the main server where he may make an order and pays by a credit card, in cash or by any other money transfer method known in the art. The tour guide transfer the desired service by Bluetooth, disc on key, USB cable, wire transition or any other transferring method know in the art to the client, who can use it immediately.

In another aspect of this invention, the products that can be marketing in this invention can be any digital product, for example, but not limited to: digital books, cellular communication airtime, internet connection, money exchange, digital music, movies, digital album, digital video clip etc.

In another aspect of this invention a tourist can purchase from this system cheep telephone calls, internal or external calls as “air time” for a cellular phone. They purchase this calls as fitted to their needs. The system has some options and some bundles, in which the tourist choose from, according to his needs and his budget. The tourist may press a button of the preferred option of the tour guide personal device or ask the tour guide to do it for him, after he enters the guide code he pays by a credit card, in cash or by any other money transfer method known in the art. The tour guide transfers the desired telephone bundle by Bluetooth, disc on key, USB cable, wire transition or any other transferring method know in the art to the client, who can use it immediately.

In another aspect of this invention a tourist on an organized tour can purchase from this system an internet subscription. He purchases an internet option as fitted to his needs. The system has some options and some bundles, in which the tourist choose from, according to his needs and his budget. The tourist may press a button of the preferred option of his personal device or ask the tour guide to do it for him from the tour guide personal device; after he enters the guide code pays by a credit card, in cash or by any other money transfer method known in the art. The tour guide transfer the desired telephone bundle by Bluetooth, disc on key, USB cable, wire transition or any other transferring method know in the art to the client, who can use it immediately.

In another aspect of this invention a tourist can exchange money through this system as well. The tourist may press a button of the preferred option of his personal device or ask the tour guide to do it for him from the tour guide personal device after he enters the guide code pays by a credit card, in cash or by any other money transfer method known in the art. The tour guide transfer the desired sum of money by a card, Bluetooth, disc on key, USB cable, wire transition or any other transferring method know in the art to the client, who can use it immediately.

In another aspect of this invention a tourist can purchase from this system music, digital books or movies from a list they can choose from. The system has some options and some bundles, in which the tourist choose from, according to his needs and his budget. The system has a list of books, movies and music in which the tourist chooses his favorite ones, and buys them. The tourist can choose a specific category from one of books, movies and music and buy them separately, or as a bundle options that exist in the system. The tourist may press a button of the preferred option of his personal device or ask the tour guide to do it for him from the tour guide personal device, after he enters the guide code, pays by a credit card, in cash or by any other money transfer method known in the art. The tour guide or the sell point transfer the desired telephone bundle by Bluetooth, disc on key, USB cable, wire transition or any other transferring method know in the art to the client, who can use it immediately.

In another aspect of this invention the purchase product can be an edited clip or designed album, in which the tourist send the pictures he photographs to the center, in the digital lab there are specialists who design the clip and can insert the person, or a group of persons, in the video clip as the tourist guide, or enter to the video clip additional relevant pictures from the relevant places he visited, or any other feature upon the client request. Any other clip design can be made by the tourist's request.

In another aspect of this invention the purchase product can be an edited clip or designed album, in which the tourist send the pictures he photographs to the center, in the digital lab there are specialists who design the album and can insert the person, or a group of persons, in the digital album, as the tourist guide, or enter to the designed album additional relevant pictures from the relevant places he visited, or any other feature upon the client request. Any other album design can be made by the tourist's request.

The designed album or clip can be sent to the tourist by mail, by Bluetooth, or can be delivered by disk or disk on key, by a USB cable or any other wire or wireless digital transition. The final product can also send abroad, if the tourist doesn't want to take the product with him, in order not to lose it.

The final product can also be sent to a friend as a gift to any place the client wants, online or offline. The gift can be sent as a paper album, wrapped.

As for today, there is a need of quite a lot of people, to share their experience during a tour or any other event with his “social-network friends” (such as “Facebook”)—(e.g. family, relatives, friends, colleagues, etc). One of the advantages of this invention is the option to purchase a digital album or clip which the final product can also be sent, by the client request, via a social network, as for example: facebook, linkedin, youtube or any other social network the client want his clip to be published in.

The tour guide of this invention can be a tourist guide who has a personal device who wants to give his tourist an extra service, and a digital journey experience

The term “personal device” refers to any device which can connects to the internet online or offline and includes, but not limited to, for example, a computer, laptop, i-phone, i-pad, tablet computer, smart-phones, all kinds of cellular phones etc.

In a more preferred aspect, this invention relates to a method of marketing and purchasing digital services, comprising: a tourist joining a tour with a tour guide said tour guide bringing a personal device on said tour and said tourist bringing a personal device on said tour. The tourist may view a digital services catalog including said digital services through the tourist guide personal device or through its private personal device or in a printed catalog. The tourist may press a button and reach (e.g. via a browser) the on-line store in the main server where he may make an order, after he enters the guide code, and pays by a credit card, in cash or by any other money transfer method known in the art. The tour guide transfer the desired service by Bluetooth, disc on key, USB cable, wire transition or any other transferring method know in the art to the tourist, who can use it immediately.

The company computer is the computer of a digital products supplier which provides those digital services to the tour guide and has an internet web site. This web site is connected to the tour guide and the tourists can see the digital product over there.

As used herein, the phrase “for example,” “such as”, “for instance” and variants thereof describe non-limiting examples of the subject matter.

In the description herein, buttons, icons, etc are described for accessing resources in various examples, but it should be understood that the description contemplates any appropriate means for accessing a resource and not necessarily the means explicitly described.

In the description herein, the terms database, memory and storage are used interchangeably.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination.

Unless specifically stated otherwise, as apparent from the following discussions, it is appreciated that throughout the specification discussions utilizing terms such as “selecting”, “marketing”, “purchasing”, “receiving”, “determining”, “shipping”, “compensating”, “paying”, “storing”, “saving”, “transmitting”, “providing”, “accessing”, “indicating”, “categorizing”, “outputting”, “viewing”, “communicating”, or the like, refer to the action(s) and/or process(es) of any combination of software, hardware and/or firmware. For example, these terms may refer in some cases to the action(s) and/or process(es) of a programmable machine, that manipulates and/or transforms data represented as physical, such as electronic quantities, within the programmable machine's registers and/or memories into other data similarly represented as physical quantities within the programmable machine's memories, registers and/or other such information storage, transmission and/or display element(s).

### BRIEF DESCRIPTION OF THE DRAWINGS

In order to understand the subject matter and to see how it may be carried out in practice, examples will be described, with reference to the ac suppliering drawings, in which:

### BRIEF DESCRIPTION OF THE DRAWINGS

In order to understand the subject matter and to see how it may be carried out in practice, examples will be described, with reference to the ac suppliering drawings, in which:

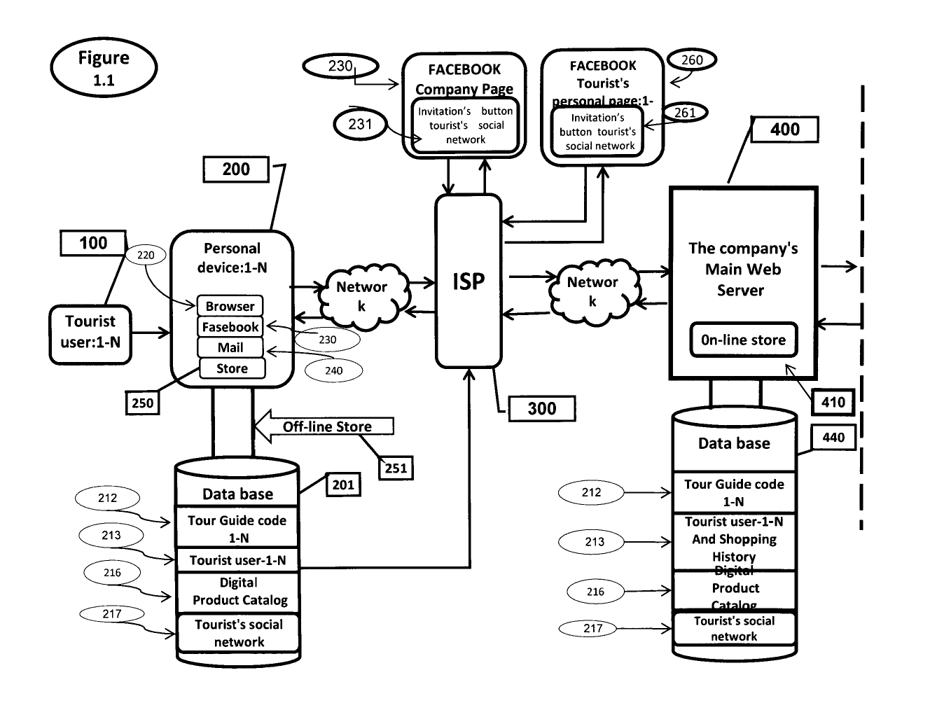

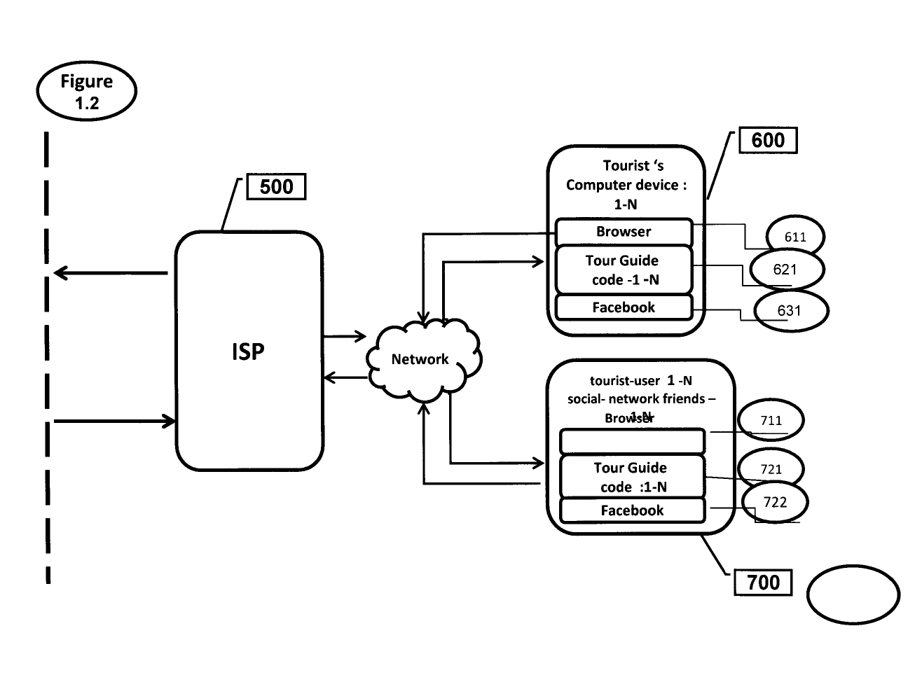

FIG. 1 (comprising FIGS. 1.1 & 1.2) is a block diagram of an example of a system for tourist product marketing and purchasing, in accordance with the presently disclosed subject matter;

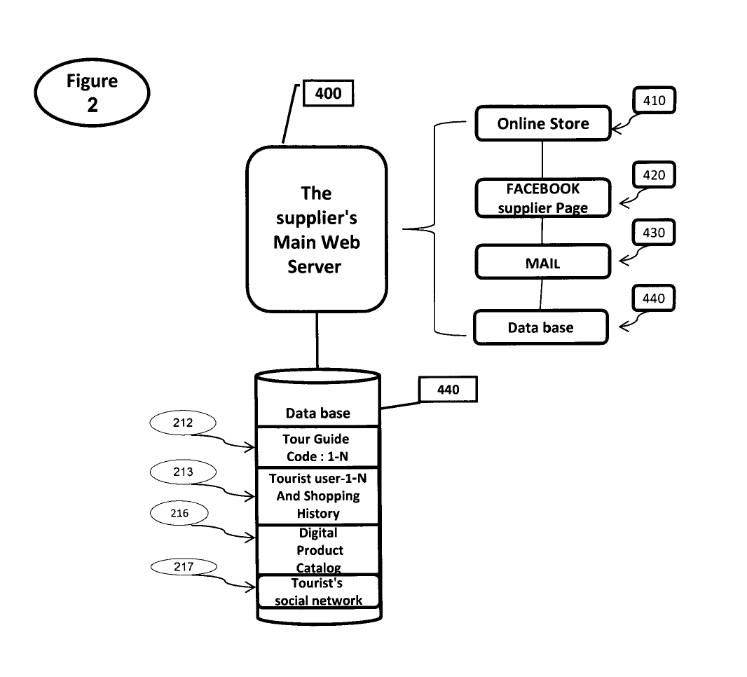

FIG. 2 is a block diagram of an example of a company's main server, in accordance with the presently disclosed subject matter;

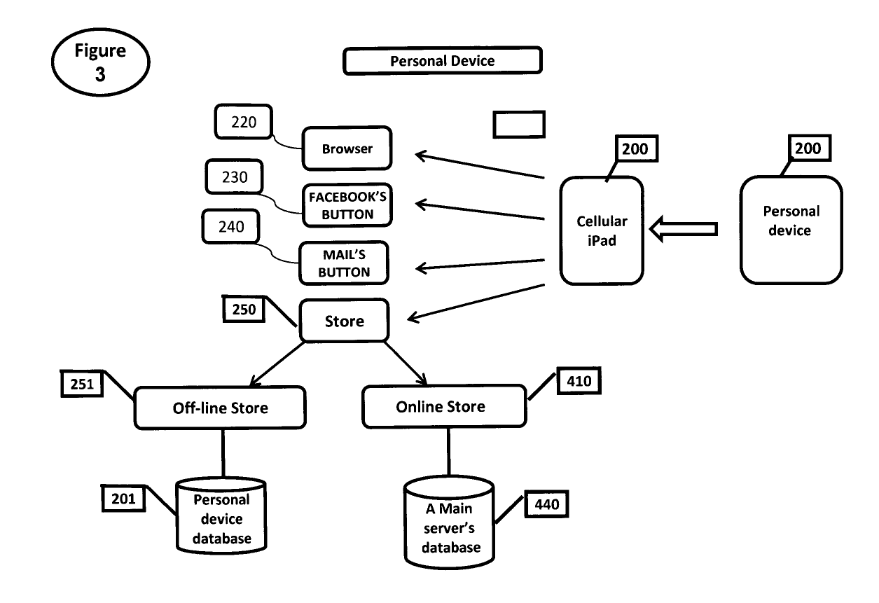

FIG. 3 is a block diagram of an example of a personal device, in accordance with the presently disclosed subject matter;

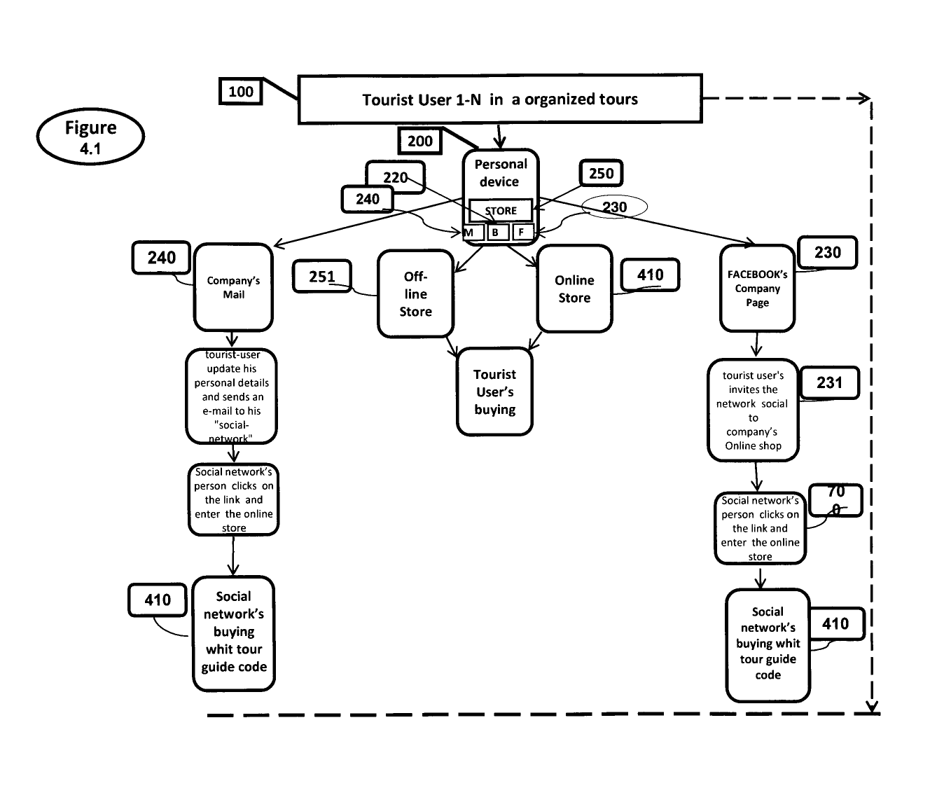

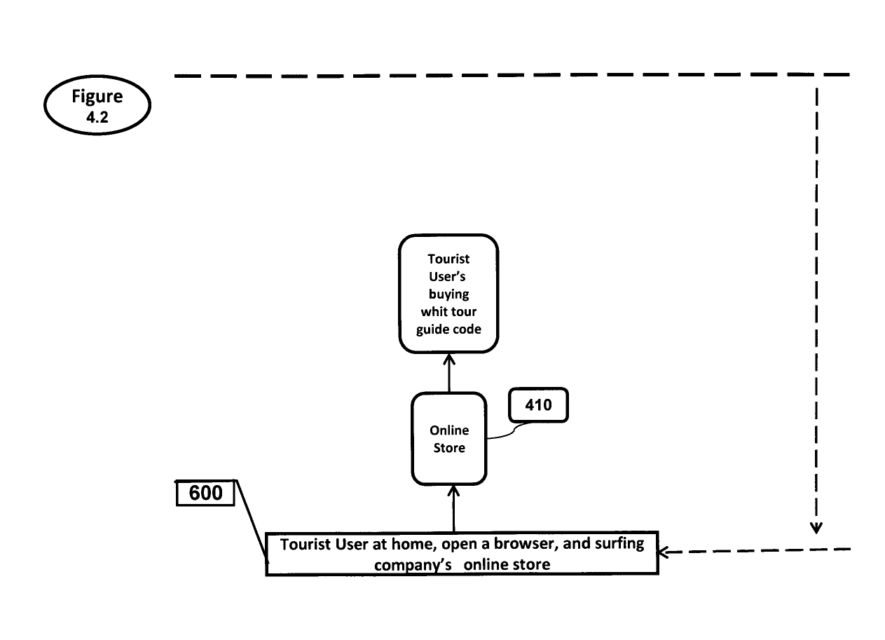

FIG. 4 (comprising FIGS. 4.1 & 4.2) is a flow chart of an example of a method of tourist product marketing and purchasing, in accordance with the presently disclosed subject matter;

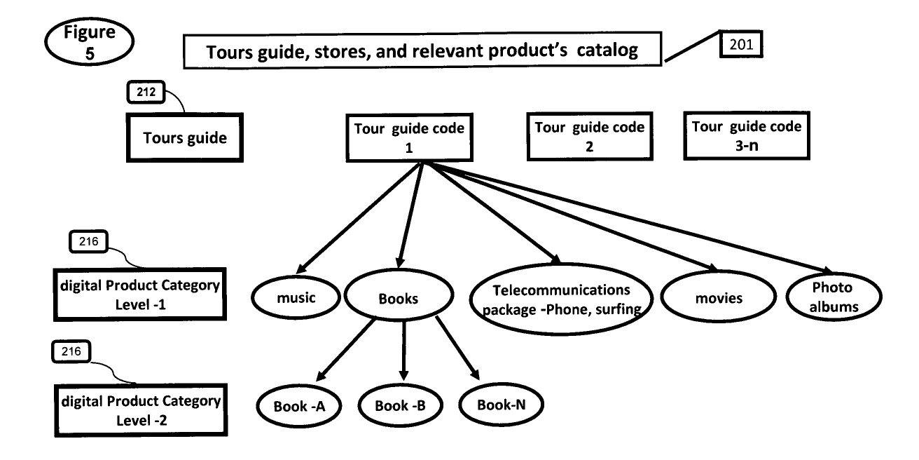

FIG. 5 schematically illustrates an example of a database on a tour guide's personal device, in accordance with the presently disclosed subject matter;

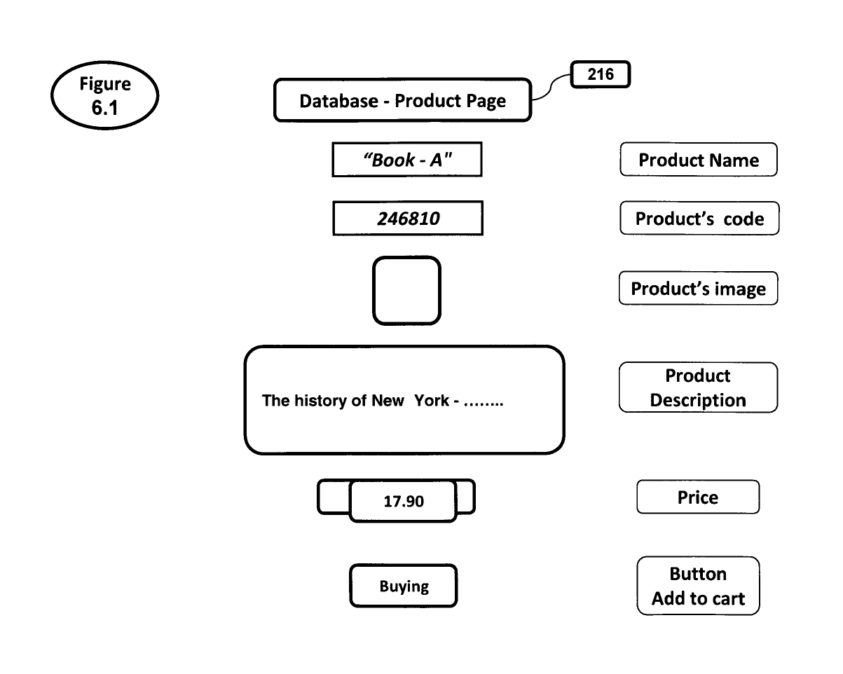

FIG. 6.1 schematically illustrates an example of a tourist product page in the company's product catalog, in accordance with the presently disclosed subject matter;

FIG. 6.2 illustrates a sample of a section of digital products from the company's product catalog, in accordance with the presently disclosed subject matter;

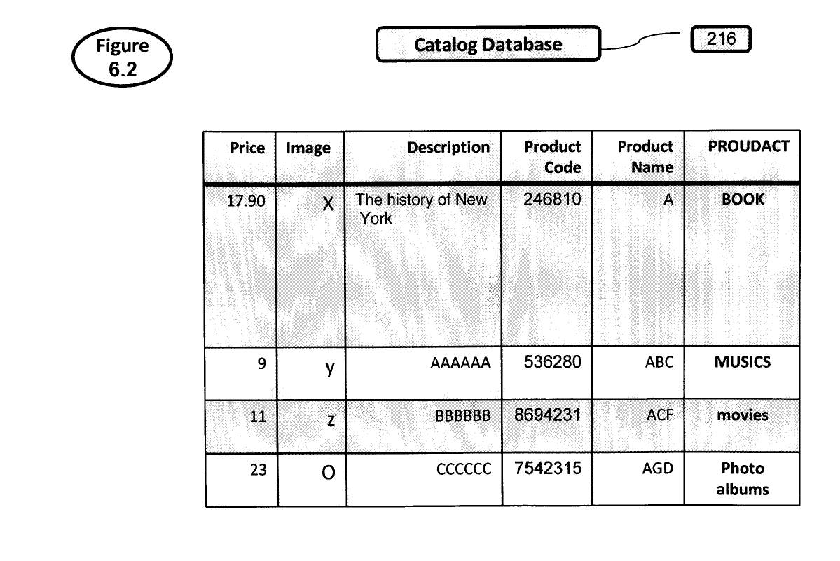

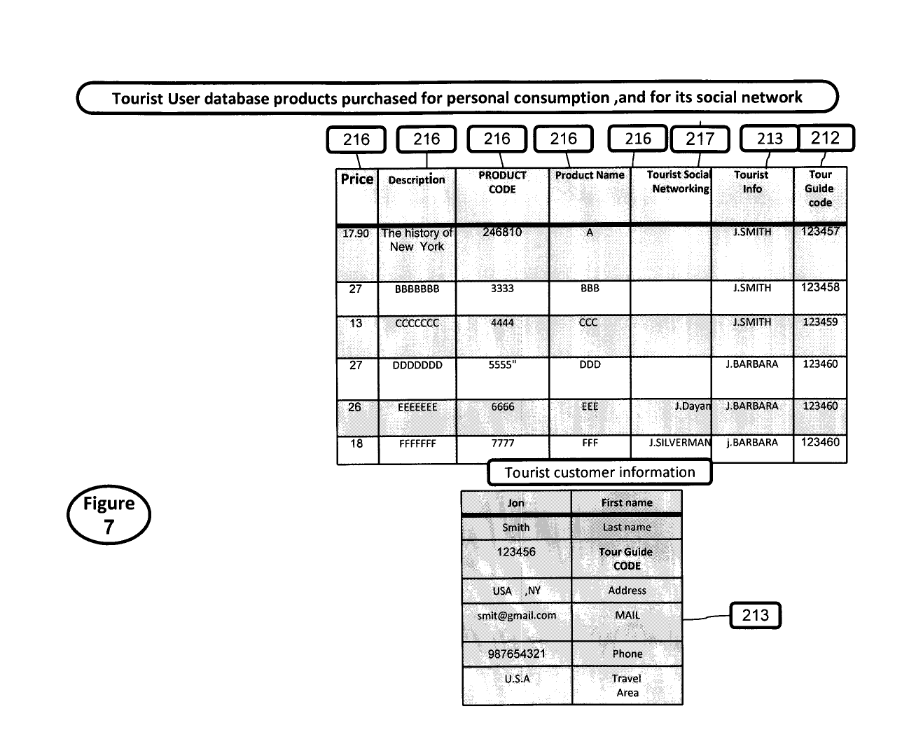

FIG. 7 illustrates a sample of a section of a database relating to tourists, in accordance with the presently disclosed subject matter;

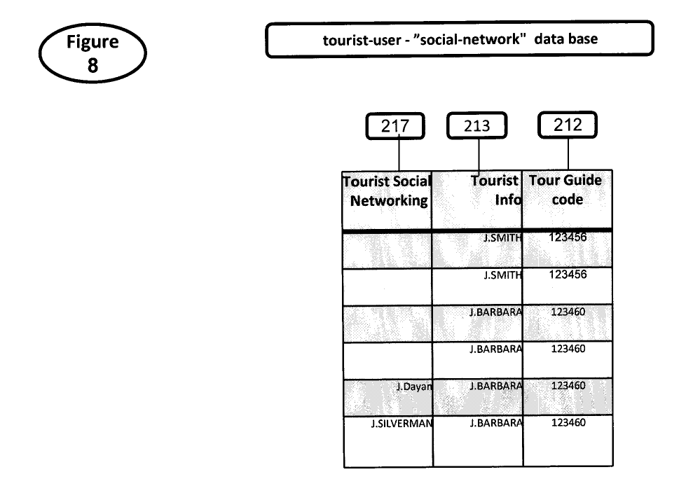

FIG. 8 illustrates a sample of a section of a database, which refers to a tourist's social network friends, in accordance with the presently disclosed subject matter; and

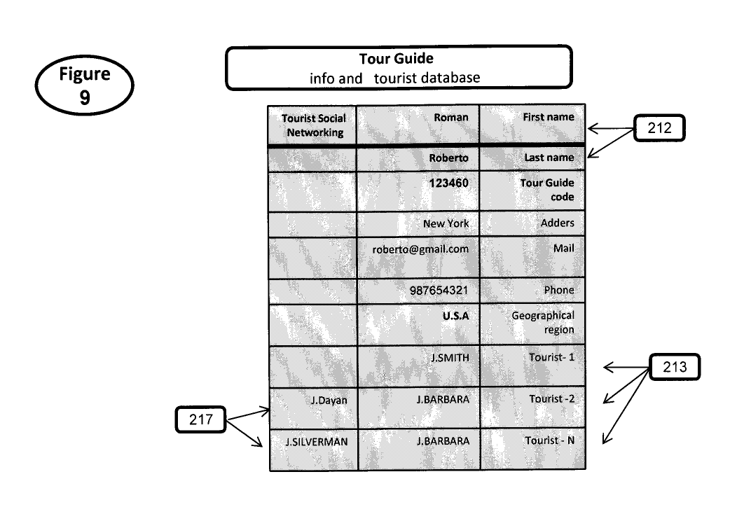

FIG. 9 illustrates a sample of a section of the tour guide's database, in accordance with the presently disclosed subject matter.

### DETAILED DESCRIPTION OF THE DRAWINGS

In the following detailed description, numerous specific details are set forth in order to provide a thorough understanding of the subject matter. However, it will be understood by those skilled in the art that some examples of the subject matter may be practiced without these specific details. In other instances, well-known stages, methods, modules, devices and systems have not been described in detail so as not to obscure the description. Referring now to the figures in more details:

Described herein are some examples of tourist product marketing system.

In the following detailed description, numerous specific details are set forth in order to provide a thorough understanding of the subject matter. However, it will be understood by those skilled in the art that some examples of the subject matter may be practiced without these specific details. In other instances, well-known stages, methods, modules, devices and systems have not been described in detail so as not to obscure the description. Referring now to the figures in more details:

FIGS. 1.1 and 1.2 illustrates the following: Tourist (100), uses his personal device or the tour guide personal device (200). Personal device as described here can be iPad, smart-phones, tablet computers, laptops, etc., or any other device which can connect to internet. Depending on the instance, each personal device (200) may belong to a tour guide or to the tourist.

When the personal device belongs to the tour guide, there are 2 options for purchasing tourist products: from an on-line store (410), or from an off -line store (251) which is programmed in the personal device's database. With the on-line option, the personal device will connect to the on-line store (410) via any kind of communication network (wire and/or wireless). For example the communication network may include the Internet. The connection will enable connection between the tourist or the tour guide's device (200) and the on-line store (410).

When the personal device belongs to the tourist, he can use the on-line store option (410) only. This connection is transferred by one or more ISP (Internet service provider(s)) (300, 500).

One or more company's server(s) are illustrated (400), with an on-line store (410), programmed in the server, in order to purchase digital products online.

The tourist, when he comes back home after the tour, can use his home personal device(s) (600), for additional purchases. Home personal devices(s) are device(s) which the tourist did not take on his tour and may include iPad, smart-phones, tablet computers, laptops, desktop computers etc., or any other device which can connect to internet. The tourist enters the tour guide code, pay for the digital product, get it through wire or wireless transition and the tour guide gets his commission.

The tourist social network friend(s)' can buy digital products as well by using their personal devices(s) (700). Social network friend(s) may include—the tourist's family, relatives, friends, work colleagues, etc. User devices may include iPad, smart-phones, tablet computers, laptops, desktop computers etc, or any other device which can connect to internet. Those people—the social network friends can enter the tour guide code (721), pay for the digital product, get it through wire or wireless transition and the tour guide gets his commission.

The communication network is one or more communication network(s) (wired, and/or wireless), which enables communication between any of personal device(s) (200), tourist home personal devices(s) (600), social network friend(s') user device(s) (700) and/or the on-line store (410) on the company's main server. For example the communication network(s) may include the Internet. This system connects between the tour guide personal code (212), and the tour guide and gives him his commission.

In some method examples, a tourist (100) that joins a touring group can make an order by using a personal device (200) belonging to the tour guide or to himself in 2 ways: He can make his order at the off-line store which is programmed in the tour guide's personal device database (200). When the personal device later connects via communication network(s) to the main server, the order will be transmitted to the main server, or he can make his order at the on-line store (410) which is programmed in the company's main server (400) assuming he's connected to the communication network, for example via an ISP (Internet service provider) (300). For example, the ISP (300) may connect the tourist to the Internet. Continuing with the example, once he is connected to the Internet, the tourist may open the browser (220), press a button or input the store's website address in order to enter the on-line store (410) which is programmed in the company's main server (400) and make his order.

More specifically, when the tourist wishes to purchase one or more of the company's digital products (216) at the on-line store, he may use the browser (220) on the personal device (200) (the tour guide's device or his own device), press a button or enter the website address in order to enter the company's on-line store (410) and purchase the digital products he wishes to buy (216). The on-line store, located on the company's server (400) receives the request of the tourist (100) to display one or more digital products (216). An on-line page is sent to the tourist with the information about the tourist product such as name of product, picture, technical specification, price, and two optional shipping fees. After choosing a shipping address, the tourist may fill in his personal details (213), the tour guide code (212) and finish the order.

Additionally or alternatively, in some method examples, the tourist(100) search process and the history of tourist product he was interested in are saved on the company's main server's (400) database (440), so that the company can stay in contact with the tourist, for example for future marketing and/or any other purpose.

Additionally or alternatively, in some method examples, the tourist(100) opens the browser (220) on the personal device (200) and via a button or website address enters the company's on-line store at the company's server (400) or enters the company's Facebook (or other social network) page. At the store's website or at the store's Facebook (or other social network) page he may press a button (230) and invite his social-network friends (700) from, for example, his “Facebook” page (or any other social-network). Additionally or alternatively, he may enter the on-line store at the company's server (400) to view and order the digital products and after he enters the tour guide personal code (721), it would be sent by wire or wireless transition, worldwide. The tour guide will get his commission.

Additionally or alternatively, in some method examples, when the tourist (100) returns home he may use his home personal device (600), or if it was the personal device (200), connect to a communication network, for example via his own Internet Service Provider (500) open a browser (611) in order to enter the company's on-line store (410) at the company's server (400), make an order and fill in his personal details (213) and shipping details and after he enters the tour guide personal code (721), it would be sent by wire or wireless transition, worldwide. The tour guide will get his commission.

Additionally or alternatively, in some method examples, the tourist (100) may take a picture during the tour, using the personal device's camera or any other camera, and the system will upload it to the tourist social webpage on, for example, Facebook (230) (or any other social-network) using browser 220.

On the company's page he may press a button (231) in order to invite his social-network (260) from his “Facebook” page (or any other social-network such as “MySpace”, etc.) to enter the company's page (230) and view the picture that was taken in the tour. The tourist's social-network friends could subsequently press a button that would lead them to the company's on-line store (410) where they can view the company's catalog; make an order, enters the tour guide code (721), and get the product by wire or wireless transition. The tour guide will get his commission.

Additionally or alternatively, in some method examples, a tourist (100) who may or may have not ordered any digital product from the tour guide while on the tour may be interested in receiving information from the supplier in the future via e-mail. Using the personal device (200), the tourist may enter his personal details (213) such as name, e-mail address, phone number and personal address, accessible via the browser (220). In some cases, these details may additionally or alternatively be stored at the company's main database in order that the company can stay in contact for future marketing and/or any other purpose. In some of these examples, when the tourist (100) returns home at the end of the tour, opens the browser (611) on his personal device (600) and enters his e-mail box, he may see an email message from the company with a link to the company's on-line store (410) where he can view the company's catalog, make an order enters the tour guide code (721), and get the product by wire or wireless transition. The tour guide will get his commission.

In some method examples, during the tour, the tourist can enter his e-mail box (e.g. Gmail, Hotmail, etc) (240) via the browser (220) or via a separate email application on the personal device (200), fill in the email address of a person from his social-network, and send a recommended link to the on-line store (410) to that person. That person would open the browser (711) or separate email application on his user device (700) to enter his own e-mail box and receive the tourist (100) recommendation including the link to the company's on-line store (410). When that person enters the on-line store he can make an order of the digital products, enters the tour guide code (721), and gets the product by wire or wireless transition. The tour guide will get his commission.

In the illustrated example, FIG. 2 includes an on-line store (410), a link to the company's network, for example, a “Facebook” page (420) (e.g. via a browser), e-mail access (e.g. via a browser or via a separate email application) (430) and the company's data base (440). In some cases, the main server collects information from the activity of the personal devices (200) belonging to each associated tour guide and information from the activity of private devices (200) belonging to tourists.

FIG. 3 illustrates an example of a personal device (200) belonging to a tour guide. In the illustrated example, the following programs are shown installed on this device: a browser (220) which would help the tourist connect to the on-line store (410) that is on the company's main server; an e-mail application (240) accessed via the browser or separately, in order to send e-mails, to update the tourist information or information about the tourist's friends from his “social-network” (700); and a network icon (230), for example, “Facebook” or any other network, for example in the browser (220), which will lead the tourist to the company's network page.

In the illustrated example, there are two options: on-line connection (wireless and/or wired connection)—In this case the user may press a button (250) and reach (e.g. via a browser) the on-line store (410) in the main server (400) where he may make an order. Off-line—then the user could press a button (250) and reach the off-line store (251) which is programmed in the personal device's database (200) and may in some cases offer the same catalog as the on-line store. The user could make an order in the off-line store and when the device later connects to the main server, the order may be transmitted to the main server.

FIGS. 4.1 and 4.2 are a flow chart of an example of a method of digital product marketing and purchasing, or more specifically examples of processes which the tourist, the tour guide and the tourists' social network, go through while marketing/purchasing tourist product(s).

In some of these instances, the first stage includes the tourist (100) opening a browser on his device or on the tour guide's device (200). The next stage includes the tourist pressing the button “store” (250) and enters the on-line store (410) which is on the company's main server (400). He can view the on-line store catalog and make an order. After choosing the digital products he wishes to purchase, he fills in his personal details, enters the tour guide code (721), and gets the product by wire or wireless transition. The tour guide will get his commission.

Additionally or alternatively, in some of these instances if there is no connection to any cellular internet (or any other connection) or for any other reason, the tourist could use the tour guide's device (200) and make his order in the off-line store (251) which is programmed in the tour guide's device's database. When the personal device will later connect to a communication network (wireless and/or wired) the information will be uploaded to the company's server for making the order.

In some instances, the personal device (200) belongs to the tourist. In some of this instance the tourist user can open the browser on his personal device and type in the on-line store website address (251), and enter the store (251) where he could make his purchase.

In the illustrated example, additionally or alternatively, an action the tourist can do is to invite his social-network friends (700) from his network, for example, a Facebook page to the company's online store (410). In this case, the tourist has 3 options: The tourist (100) may open a browser in the device (200). By pressing the button “Facebook”, for example, (230) (FIG. 1.1) he may visit the company's page in the social-network of “Face book”. On the company's page, he may press a button (231) (FIG. 1.1) to invite his social-network friends from “Facebook” or any other network, to enter the company's page (230) and view the company's catalog and the variety of digital products it offers.

The tourist may use a browser in the tour guide's device (200) (or in his own device) to open his personal page in “Facebook” and invite his social-network friends (700) to enter the company's page on “Facebook” (230). The tourist may take a picture during the tour, using the device's camera or any other camera, purchase a digital album or clip, and the system will send it to his personal page on, for example, a “Facebook” (260) or any other network, and leave a message that invites his social-network friends (700) to enter the company's page (230) and view the picture. Visiting the company's page will expose the social-network friends to the variety of digital products that the company is selling and will enable them to purchase for themselves any digital product they desire by entering the tour guide code.

In the illustrated example, additionally or alternatively, an action that the tourist may do uses an e-mail application (such as Gmail, Hotmail, etc.) which is in the browser or is a separate application: The tourist may open the email application (240) using the personal device (200) and update his personal details in order to receive future messages (tourist product offers, newsletters, etc) from the company. After returning home, the tourist (600) can open his home/work device, enter his e-mail application, open the company's message (e.g. offer, newsletter), and press a link included in the email that would lead him to the company's on-line store (410) where he can make an order.

In the illustrated example, additionally or alternatively, the tourist may open his e-mail box (240) and send an e-mail to his “social-network” friends. In the sent e-mail there may be a link to the on-line store and a recommendation to visit the company's website.

FIG. 5 schematically illustrates a database 201 on a personal device belonging to a tour guide. In the illustrated example, the database is organized by tour guide, and tourist product (216). In the illustrated example, for each tour guide, has a different catalog which connected to the tour guide by a code (212) which includes details about the digital product (s) (216) e.g. name of product, picture, technical specification, manufacture, price and etc. In some cases, the database (201) on device (200) updates from time to time from the company's database in the main server (440).

FIG. 6.1 shows an example of a single digital product in the company's product catalog (216). Such a company catalog may be in a database (440) on the main server (400) and/or in a database (201) on a personal device (200). The tour guide catalog connected to the tour guide by a code (212). In the illustrated example the details about the digital product include: name of product, picture, description of the product, technical specification, price, manufacture and address for shipping if it send as a gift.

FIG. 6.2 illustrates a sample of a section of digital products from the company's product catalog. Such a company catalog may be in a database (440) on the main server (400) and/or in a database (201) on a personal device (200). The tour guide catalog connected to the tour guide by a code (212). In the illustrated example, the data shown includes name of product, picture, and description of the product, technical specification, price and other relevant details.

FIG. 7 illustrates a sample of a section of a database relating to tourists. Such tourist data may be in a database (440) on the main server (400) and/or in a database (201) on a personal device (200). For instance, during the tour, when connection is available, the tour guide's (200) device will connect to the company's server (400) and updates automatically the new information in the company's main database (440).

In the illustrated example, the sample of a section of tourist data on the company's main database (440) includes: one or more tour guide details (212), one or more geographic areas (212), one or more tourist's detail (213) e.g. first and family name, e-mail address, phone number, order, shipping address, etc.

FIG. 8 illustrates a sample of a section of a database, which refers to a tourist's social network friends (700). Such social network data may be in a database (440) on the main server (400) and/or in a database (201) on a personal device (200). In the illustrated example the tourist can invite his social-network friends (700) to the company's network page, for example, a “Facebook” page (231) (FIG. 1.1). These details would be saved in the company's database (217) and may be helpful for future advertising and marketing and/or other purposes.

In the illustrated example, if the tourist is using his own personal device (200) he's requested to enter the tour-guide's code (212) in order to ascribe him and his social-network friends as the consumers of that specific tour guide, in the company's database, so that the company can pay the tour guide his commission (or any other service payment that may be defined in the future). If the tourist is instead using the tour guide's personal device (200) the tour guide's code (212) may be automatically provided to the company's database.

In the illustrated example, the commission payment for the tour guide is given for orders that were made by the tourist during the tour, orders that he will make after he returns home from the tour and orders that are made by his social-network friends.

FIG. 9 illustrates a sample of a section of the tour guide's database relating to his code (212), including all the tourist details that joined his tours and their social-network friends (213), who bought digital products from the company. The data from database (212) may also be saved to the company's main server (400).

Any of the modules, systems, and/or devices described herein and/or illustrated in the figures may be made up of any combination of software, hardware and/or firmware that performs the functions as described and explained herein. In some cases, any of the systems, devices and/or modules, or any part(s) thereof may comprise a machine specially constructed for the desired purposes, and/or may comprise a programmable machine selectively activated or reconfigured by specially constructed program code. In some cases, at least one of the systems, modules and/or devices includes at least some hardware. In various cases, any of the systems, modules and/or devices may be centralized in one location or dispersed over more than one location.

Alternatively to the examples shown and described herein, the modules, systems and/or devices may in some examples include less, more and/or different functionality, and/or functionality may be divided differently than described and shown.

Alternatively to the examples shown and described herein, method stages which are shown and described as being executed sequentially may in some examples be executed in parallel and/or stages shown and described as being executed in parallel may in some examples be executed sequentially. Alternatively to the examples shown and described herein, any method may in some examples include more, less and/or different stages than described and shown. Alternatively to the examples shown and described herein, stages in any method may in some examples be executed in a different order than the order described and shown.

In some of these examples, the disclosed methods and systems allow the tourist to continue to purchase different digital products he was exposed to during the tour, and new digital products as well, in a convenient place, and efficiently in terms of time.

In some of these examples, an important aspect of the disclosed methods and systems is the information that is available to the consumer (e.g. tourist or friend from social network). Via one or more communication networks such as the Internet, the consumer may be informed of a large amount of detail about the digital products such as: a video clip of the products, information about the content of the product's package, price comparisons, recommendations of other consumers, and/or any other relevant information.

In some of these examples, the disclosed systems and methods provide the ability to send digital products to the tourist's house, or to his “social-network” friend's house as a gift.

In some of these examples, the disclosed methods and systems allow the tourist, to recommend to his “social-network” friends the company's site and on-line store, and to invite them to view the catalog and shop according to their needs.

While examples of the subject matter have been shown and described, the subject matter is not thus limited. Numerous modifications, changes and improvements within the scope of the subject matter will now occur to the reader.

1. A digital journey experience system on organized tours for marketing and purchasing products by a personal device, which by entering a tour guide personal code can sell digital products during a journey and the tour guide get a commission for each sell. This system comprising: a server operable to receive an indication of a purchase by a tourist while on tour or from home, the server transfers the selected product via any digital transition, wire or wireless transition to the tourist and the tour guide get his payment.

2. A digital journey experience system of claim 1 in which the personal device is a personal device of the tourist or of the tour guide.

3. The system of claim 1 in which the tourist may view a digital or printed services catalog including said digital services through the tour guide personal device or through the tourist private personal device.

4. The system of claim 1 in which the wire or wireless transition is made by Bluetooth, disc on key or USB cable or by any other money digital transfer method

5. The system of claim 1 in which the payment is made by a credit card, in cash or by any other money digital transfer method.

6. The system of claim 1 in which the products which can be purchase from this system are digital books, cellular communication airtime, interne budget, money exchange, digital music, movies, digital album, digital video clip.

7. A method of marketing and purchasing digital services, comprising: a tourist joining a tour with a tour guide said tour guide bringing a personal device on said tour and said tourist bringing a personal device on said tour. The tourist may view a digital services catalog including said digital services through the tourist guide personal device or through its private personal device or in a printed catalog. The tourist may press a button of the preferred option of his personal device or ask the tour guide to do it for him from the tour guide personal device and reach (e.g. via a browser) the on-line store in the main server where he may make an order, after he enters the tour guide code, and pays. The tour guide gets his commission and transfers the desired service by any digital wire or wireless transition to the client, who can use it immediately.

8. The method of claim 7 in which the tourist may view a printed or digital services catalog including said digital services through the tour guide personal device or through the tourist private personal device.

9. The method of claim 7 in which the wire or wireless transition is made by Bluetooth, disc on key or USB cable.

10. The method or system of any one of claim 7 in which the payment is made by a credit card, in cash or by any other money digital transfer method.

11. The method or system of claim 7 in which the products which can be purchase from this system are digital books, cellular communication airtime, interne budget, digital music, money exchange, movies, digital album, digital video clip.

12. The method or system of claim 7 in which the products that can be purchase in this system are digital books, digital music or movies which the user can choose from a list.

13. The method or system of claim 12 in which the product that can be purchase in this system is a designed digital album or digital video clip which designed according to the tourist request.

14. The method of claim 7 in which the tourist pays for the service on a daily basis, per weak or per month according to the system options.

15. The method of claim 7 in which the tourist buys a bundle according to the system options.

16. The designed album or clip according to claim 12 which is sent to the tourist by mail, by Bluetooth, by disk or disk on key, to the tourist or sends abroad.

17. The designed album or clip or any other digital product in the digital journey experience system according to claim 7 in which the final product sent to a friend and social network as a gift to any place the client wants, online or offline.

18. The designed album or clip according to claim 12 in which the digital album or clip is sent via a social network per the client request.

19. The digital journey experience system of claim 7 in which every one of the tourist friend on the social networks can order a digital product, enter the tour guide code, get the product and the tour guide gets a commission.
